(19) United States
(12) Patent Application Publication
(10) Pub. No.: US 2013/0186574 A1
(43) Pub. Date: Jul. 25, 2013

(54) Fiber Batt Reclaiming Method and Apparatus

(71) Applicants: Kevin D. Baker, Las Cruces, NM (US); Sidney E. Hughs, Las Cruces, NM (US)

(72) Inventors: Kevin D. Baker, Las Cruces, NM (US); Sidney E. Hughs, Las Cruces, NM (US)

(21) Appl. No.: 13/358,110

(22) Filed: Jan. 25, 2012

(51) Int. Cl. B29C 59/06; B29C 59/04

(52) U.S. Cl. 156/707; 156/759; 156/758; 156/715

(57) ABSTRACT

The fiber batt reclaiming method and apparatus separates the fiber batt portion of surplus or defective fiberglass insulation from the paper backing material attached to the fiber batt. As the insulation is fed to a perforated roller, a vacuum means draws the backing material to the roller so that the backing material adheres to the roller. As the roller rotates the fiber batt portion of the insulation is separated from the backing material by a separation tool. In accordance with various embodiments of the apparatus, the separation tool may be an elongated knife, a pressurized air bar, a circular saw bar, or an elongated wire brush.

### FIELD OF THE INVENTION

The present invention relates to a method and apparatus for separating the backing portion of fiberglass insulation from the remaining fibrous (fiberglass) material that comprises the bulk of conventional insulation.

### BACKGROUND OF THE INVENTION

During the manufacture of fiberglass insulation, defects occur that cause the fiberglass manufacturers to reject significant amounts of insulation materials. A typical manufacturer may reject as much as 40 to 60 tons of material each month. Currently, manufacturers manually separate the fiberglass from its backing, and then recycle the separated fiberglass material.

However, the manual fiberglass separation process leaves significant quantities of the fiberglass attached to the backing material. Consequently, the fiberglass that remains attached to the backing is wasted and frequently ends up in a landfill. Further, manually separating the fiberglass from its backing is a tedious, time-consuming, labor-intensive task that requires workers to wear special protective gear.

The need exists for a more effective and efficient means of removing fiberglass insulation from its backing. The current invention comprises a method and apparatus that allows manufacturers to achieve a nearly complete (99%) separation of materials at a faster rate than can be done manually and with significant cost savings. The invention increases the amount of recyclable insulation, reduces labor costs, reduces waste, and reduces manufacturer landfill fees.

### SUMMARY OF THE INVENTION

The current invention is directed to a fiber batt reclaiming system. The system includes a vacuum means that applies a suction force to a perforated roller. Defective or surplus insulation is fed to the roller so that the suction causes the backing portion of the insulation to adhere to the roller. As the roller rotates, a fiber batt portion of the insulation is separated from the backing by a fiber batt separation tool. In accordance with various embodiments of the system, the separation tool may be an elongated knife, a pressurized air bar, a circular saw bar, or an elongated wire brush.

### BRIEF DESCRIPTION OF THE DRAWINGS

FIG. 1 is a perspective view of the perforated vacuum roller of the preferred embodiment.

FIG. 2 is profile schematic view of the apparatus of the preferred embodiment illustrating the use of a knife to separate the fibrous insulation from the backing material.

FIG. 3 is profile schematic view of the apparatus of an alternative embodiment illustrating the use of an air bar to separate the fibrous insulation from the backing material.

FIG. 4 is profile schematic view of the apparatus of a further alternative embodiment illustrating the use of a saw wheel to separate the fibrous insulation from the backing material.

FIG. 5 is a profile schematic view of the apparatus of an additional alternative embodiment illustrating the use of a wire bar (i.e. a brush) to separate the fibrous insulation from the backing material.

### DETAILED DESCRIPTION OF PREFERRED EMBODIMENTS

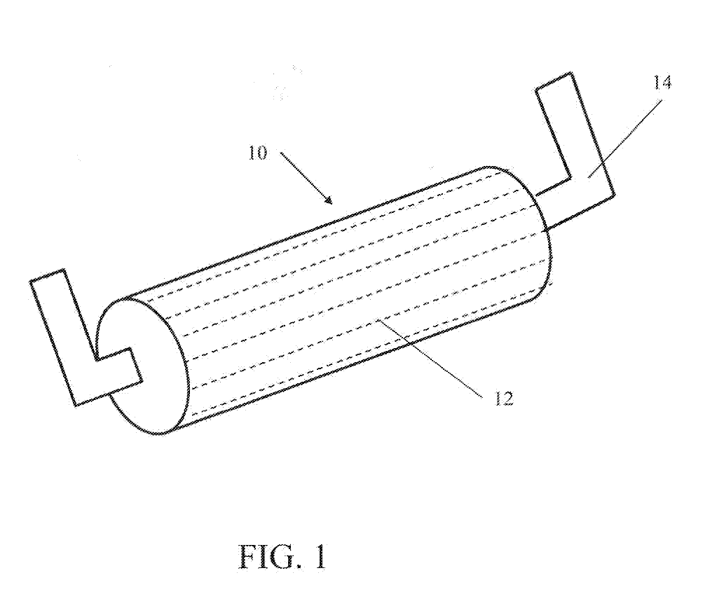

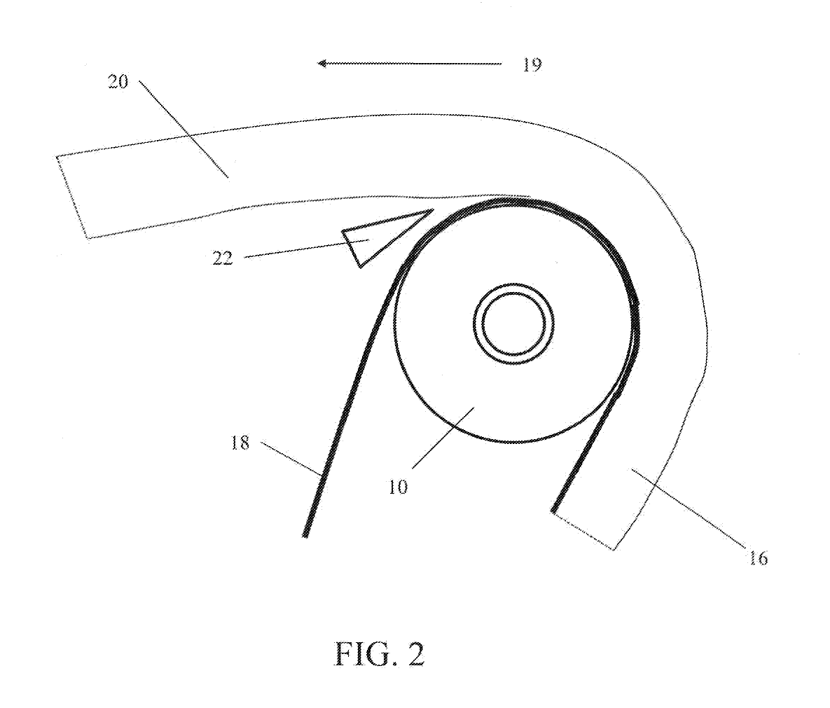

The current invention generally comprises a method and apparatus for separating (preferably) fiberglass insulation from a backing material. As generally shown in FIG. 1, an important aspect of the invention is a vacuum roller 10. The roller 10 includes multiple perforations 12. Piping or ducting 14 extends from the end portions of the roller 10. The ducting 14 is connected to a centrifugal fan or other means for creating a suction or vacuum within the roller 10 so that air is continuously drawn through the perforations 12. FIGS. 2-5 show the roller 10 with the ducting 14 removed. In operation, the suction means draws air (via the ducting 14) through the roller perforations 12 so that fabric, paper, or materials that are positioned adjacent to the roller 10 are drawn into contact with the roller 10 and adhere to the roller 10.

In the preferred embodiment, the roller 10 has a diameter of 20 inches and the perforations 12 have a diameter of 0.0625 inches arranged in a pattern that has 15% open area. In alternative embodiments the roller 10 may have a diameter in the range of 12 to 36 inches, and the perforations 12 may have a diameter in the range of 0.0625 to 0.125 inches arranged in a pattern that has from 5 to 15% open area.

In the preferred embodiment the suction means comprises a centrifugal fan and the suction force apparent at the roller perforations 12 is at least 8 inches of water column vacuum. In alternative embodiments, the suction force (or pressure drop, etc.) apparent at the perforations 12 is in the range of 8 or more inches of water column vacuum. The suction force may be generated by other types of fans, or pumps, or by any means known in the art.

As best shown in FIG. 2, in the preferred embodiment, fiberglass insulation 16 (generally defective, excess, or otherwise unacceptable insulation) is processed by drawing the insulation 16 over the roller 10 so that suction from the roller perforations 12 causes the insulation backing material 18 to adhere to the roller 10. As the roller 10 rotates, insulation 16 is drawn over the roller 10 in the direction of the arrow 19. As the roller 10 continues rotate, the insulation fiber batt 20 is separated from the backing 18 by a separation device. In the preferred embodiment shown in FIG. 2, the separation device (i.e. “separation tool”) comprises an elongated bar with a sharpened edge (i.e. a “knife”) 22.

In the preferred embodiment, the insulation 16 is processed (i.e. the backing material 18 is separated from the fiber batt 20) at a rate of 100 feet per minute. In alternative embodiments the insulation may be processed at a rate in the range of 50 to 200 feet per minute.

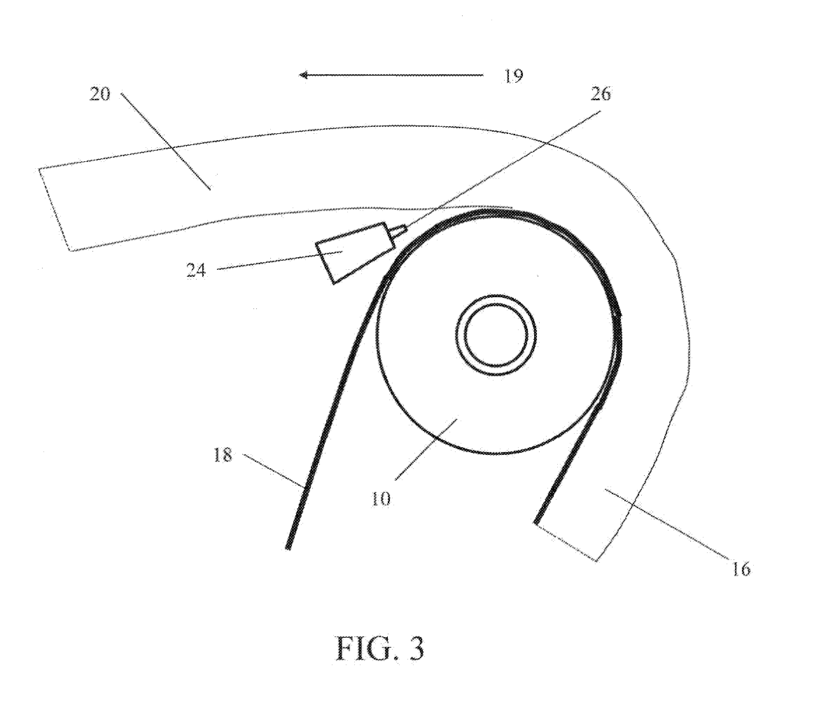

As shown in FIG. 3, in a second embodiment, the insulation 16 is processed as described above, however, an air bar separation device 24 is used to separate the insulation 16 backing material 18 from the fiber bat 20. The air bar 24 comprises an elongated manifold with a plurality of nozzles (or alternatively simple apertures) 26 that direct pressurized air to a designated separation point between the backing material 18 and the fiber batt 20. In the preferred embodiment, the nozzles generate an airstream of 10 cfm at 20 psig. In alternative embodiments, the airstream flows at a rate in the range of 10 cfm at 20 psig up to 36 fm at 100 psig.

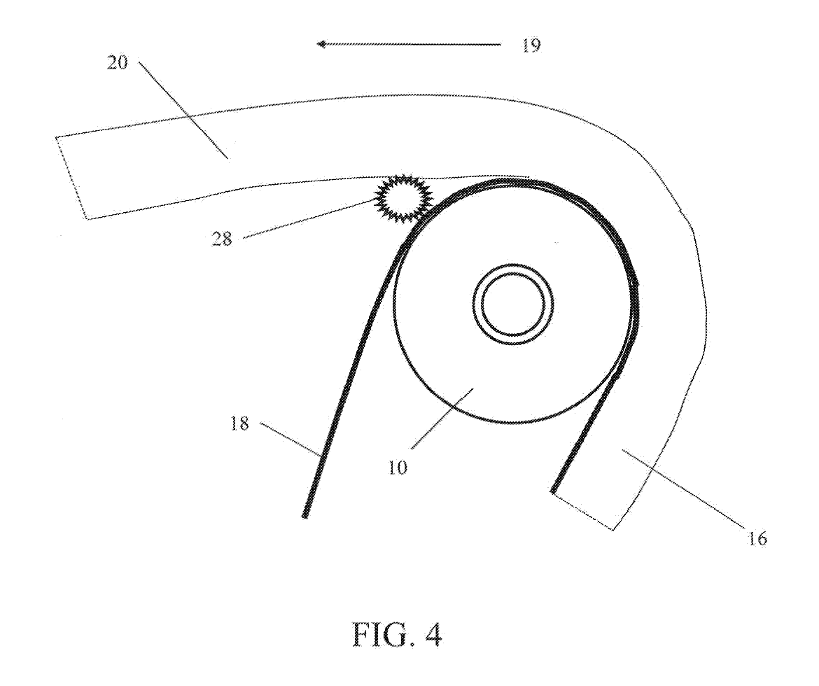

Similarly, as shown in FIG. 4, in a third embodiment, the separation device comprises a saw wheel 28. The saw wheel 28 comprises a plurality of thin circular saw-type blades that grasp the insulation 16 fiber 20 and cut the fiber batt 20 away from the backing material 18. In the preferred embodiment, the saw has a diameter of 12 inches and operates at 550 rpm. In alternative embodiments, the saw may have a diameter ranging from 12 to 24 inches and operating at 300 to 1100 rpm

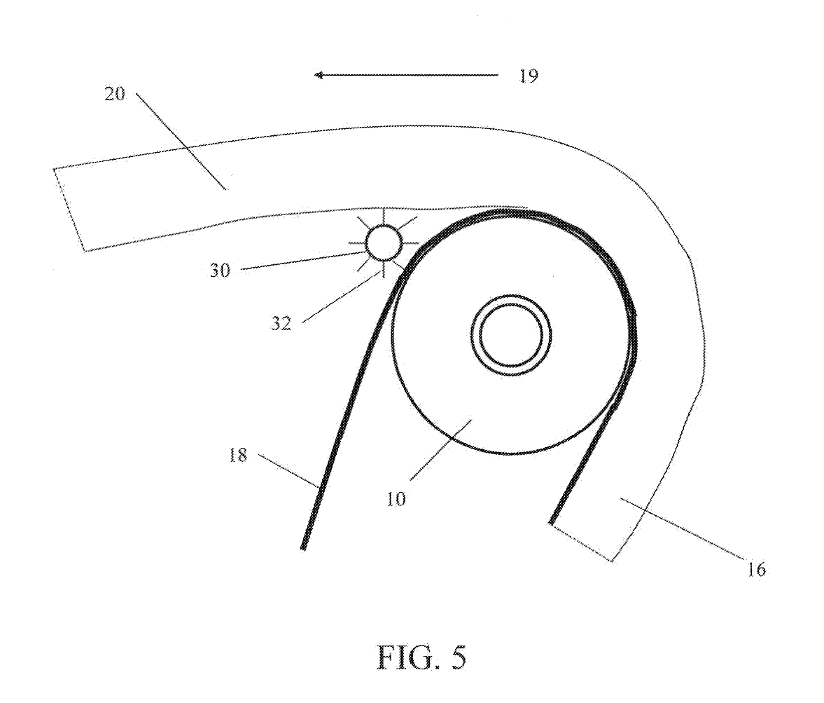

In a fourth embodiment (shown in FIG. 5), the separation device comprises a “brush” 30. The brush 30 comprises an elongated body with multiple flexible bristles 32 extending outwardly. The bristles 32 pull the fiber batt 20 away from the backing material 18. In the preferred brush embodiment, the brush has a diameter of 16 inches with 16 sets of bristles and operates at 1240 rpm. In alternate embodiments, the brush may have a diameter ranging from 12 to 24 inches with 12 to 24 sets of bristles and operating at 675 to 2500 rpm.

For the foregoing reasons, it is clear that the invention provides an innovative fiber batt reclaimer. The invention may be modified in multiple ways and applied in various technological applications. For example, although fiberglass insulation is the primary material discussed herein, the current method and apparatus may be used to separate other fibrous and non-fibrous materials. Further, the current invention may be modified and customized as required by a specific operation or application, and the individual components may be modified and defined, as required, to achieve the desired result.

Although the materials of construction are generally not specified, they may include a variety of compositions consistent with the function of the invention. Such variations are not to be regarded as a departure from the spirit and scope of the invention, and all such modifications as would be obvious to one skilled in the art are intended to be included within the scope of the following claims.

What is claimed is:

1. A fiber batt reclaiming apparatus comprising:
a roller; and
a separation tool;
whereby as the roller rotates, a backing material attached to a fiber batt is drawn to the roller so that the separation tool is positioned to separate the fiber batt from the backing.

2. The apparatus of claim 1 wherein the roller comprises a perforated roller.

3. The apparatus of claim 1 wherein the roller is structured so that a vacuum emanating from the roller causes the backing to adhere to the roller.

4. The apparatus of claim 1 wherein the apparatus is structured so that after the backing is separated from the fiber batt, the backing continues to adhere to the roller.

5. The apparatus of claim 1 wherein the fiber batt separation tool comprises a knife, the knife cutting the backing material from the fiber batt.

6. The apparatus of claim 5 wherein the knife comprises at least one sharp-edged instrument.

7. The apparatus of claim 5 wherein the knife comprises an elongated bar with a sharpened edge.

8. The apparatus of claim 1 wherein the fiber batt separation tool comprises an air bar, the air bar utilizing pressurized air to separate the backing from the fiber batt.

9. The apparatus of claim 8 wherein the air bar comprises an elongated manifold with a plurality of nozzles or apertures that direct pressurized air to a separation point between the backing and the fiber batt.

10. The apparatus of claim 1 wherein the fiber batt separation tool comprises a saw bar.

11. The apparatus of claim 10 wherein the saw bar comprises a plurality of serrated blades.

12. The apparatus of claim 10 wherein the saw bar comprises a plurality of circular-saw blades that grasp the fiber batt and cut the fiber batt away from the backing.

13. The apparatus of claim 1 wherein the fiber batt separation tool comprises a brush.

14. The apparatus of claim 13 wherein the brush comprises an elongated body with multiple bristles so that the bristles pull the fiber batt away from the backing.

15. A fiber batt reclaiming system comprising:
a perforated roller;
a vacuum means; and
a fiber batt separation tool;
whereby as the roller rotates, the vacuum means causes a backing material attached to a fiber batt to adhere to the roller so that the separation tool is positioned to separate the backing from the fiber batt.

16. The fiber batt reclaiming system of claim 15 wherein the fiber batt separation tool is selected from a group consisting of a knife, an air bar, a saw bar, and a brush.

17. A method of removing a fiber batt from an associated backing, the steps comprising:
(a) rotating a roller;
(b) inducing backing material attached to a fiber batt to adhere to the roller;
(c) separating the fiber batt from the backing.

18. The method of claim 17 wherein the roller is a perforated roller and a vacuum force applied to the roller perforations causes the backing material to adhere to the roller.

19. The method of claim 17 wherein the backing is separated from the fiber batt by a separation tool.

20. The method of claim 19 wherein the fiber batt separation tool is selected from a group consisting of a knife, an air bar, a saw bar, and a brush.
